(19) United States
(12) Patent Application Publication
(10) Pub. No.: US 2008/0164038 A1
(43) Pub. Date: Jul. 10, 2008

(54) Flame arrester

(76) Inventor: Charles Osborn Reade, Oxford (GB)

Correspondence Address: LAHIVE & COCKFIELD, LLP, ONE POST OFFICE SQUARE, BOSTON, MA, 02109-2127, US

(21) Appl. No.: 12/006,508

(22) Filed: Jan. 3, 2008

Related U.S. Application Data
(63) Continuation of application No. 09/831,605, filed on May 10, 2001, now abandoned.

(30) Foreign Application Priority Data
Nov. 10, 1998 (GB) 9824532.7

(51) Int. Cl. A62C 2/00

(52) U.S. Cl. 169/49

(57) ABSTRACT

The flame arrester comprises a flow passage in which are disposed a plurality of generally aligned rods such that fluids flowing in the passage must pass between the rods. Rows of rods are used to construct the flame arrester element, ideally closely spaced and these present a natural surface over which air can flow with minimal flow resistance. The rods can be of any size and the gaps between them can be selected to arrest explosions due to different gases or vapours in air. The rod diameter can be altered to withstand different levels of explosion pressure, making it possible to construct both deflagration and detonation flame arresters. If tubes are used these can carry cooling fluid making the arrester more effective at coping with continuous burning. Rods in parallel rows can be offset with respect to the adjacent row. Suitable offset angles can vary.

### TECHNICAL FIELD OF THE INVENTION

The present invention relates to flame arresters.

### BACKGROUND ART

Flame arresters are used either to halt an internal explosion so that it will not ignite a surrounding explosive atmosphere, or to prevent an external fire or explosion from igniting an internal explosive atmosphere that must be handled with safety within a system.

In the majority of cases it is necessary for a flow of air to pass through plant or machinery. Some plant or machinery has internal sources of ignition, and internal explosions can occur if a gas or vapour becomes entrained in the flow. In some cases there is a risk of gases or vapours in potentially explosive concentrations being ingested from outside. In other cases, where flammable materials are being pumped for example under vacuum, it is possible for a potentially explosive atmosphere to be present as part of a process. To prevent the escape of internal explosions in these applications, flame arresters are placed in pipelines and referred to as End of Line Flame Arresters.

Much plant and machinery is designed as a closed system where it is normal for potentially explosive atmospheres to be handled internally. Plant and machinery used in these applications is designed so that it does not have an internal source of ignition. Much of this type of plant and machinery has to vent to atmosphere. In cases such as this, flame arresters are normally fitted on the end of vent lines to prevent an external fire or explosion from flashing back into the plant or machinery. Flame arresters of this type are referred to as In Line Flame Arresters.

In either of the above applications it is possible for a flow of potentially explosive gas or vapour to be ignited so that it burns rather than explode. Burning at high temperature can occur very close to the surface of a flame arrester and the flame arrester must be capable of preventing a flame from igniting the gas or vapour on the safe side of the flame arrester. Flame arresters of this type are referred to as Continuous Burning Flame Arresters.

Flame arrestors can be designed to cope with two types of explosion. If an explosion progresses at velocities below the speed of sound for a given gas or vapour in air, the explosion is termed a deflagration. If the explosion occurs at the speed of sound it is called a detonation and is normally characterised by a sharp report due to the existence of a shock wave. The passages needed to prevent a detonation from transmitting to an external explosive atmosphere are much smaller than those needed to arrest a deflagration and the length of the flame path is significantly greater. Detonation flame arresters are highly resistive to a gas flow.

The majority of flame arresters of the above types are constructed from several closely adjacent panels of thin gauge materials that will burn if left in a continuous burning situation for too long. Flame arrestors made of thin gauge material are also less capable of coping with both pressure explosions without distorting. Flame arrestors made of light gauge materials do, however, present less flow resistance.

None of the existing forms of flame arrester can easily be cleaned by mechanical means, meaning that if a dirty flow of gas or vapour is involved, such flame arresters foul up and must be cleaned chemically. For example, the exhaust of a diesel engine can clog a flame arrester in as little as 8 hours. The need to regularly remove and clean flame arresters is not welcome, because this adds an extra maintenance task often means that plant and machinery must be closed down, and usually requires a stack of flame arresters to be maintained. Diesel engines can sometimes require a flame arrester, for example when fitted to a fork lift truck operating in a sensitive area.

### SUMMARY OF INVENTION

The present invention therefore provides a flame arrester comprising a flow passage in which are disposed a plurality of generally aligned rods such that fluids flowing in the passage must pass between the rods.

This provides a simple geometry and can easily be replicated precisely. It therefore complies with European requirements, which require such devices to have a regular geometric shape and dimensions that can be checked. Rows of rods are used to construct the flame arrester element, ideally closely spaced and these present a natural surface over which air can flow with minimal flow resistance. The rods can be of any size and the gaps between them can be selected to arrest explosions due to different gases or vapours in air. The rod diameter can be altered to withstand different levels of explosion pressure. It is therefore possible to construct both deflagration and detonation flame arresters.

The rods are preferably circular in cross section, but this is not essential and other profiles such as polygonal or elliptical cross-sections are possible dependant on the intended application.

A rod has a large surface area, which is important when arresting an explosion, because this is an effective heat exchange surface that will absorb more of the heat energy released by an explosion. The rods can be made of solid material such as compound tubes or hollow or tubes. If tubes are used these can carry cooling fluid making the arrester more effective at coping with continuous burning. Most known flame arresters cannot function if their temperature exceeds 100° C. and none are effective above 200° C. Conventional flame arresters are not therefore effective if a hot air flow is involved. Flame arresters according to the present invention can thereby be cooled to overcome this problem, and there is no reason why additional tubes of larger diameter and spacing should not be added upstream. These could form part of the flame arrester and take out additional heat in a flow of hot gases before reaching the arrester element. Rods used upstream can either be in the form of plain tubes or finned tubes depending on the level of heat transfer required.

Most flame arresters have a continuous open path where the flame only needs to move in one direction. Such passages laminate a flow of gas causing an explosion to be starved of air. This is beneficial, but at the same time increases flow resistance. It is also possible to look through these flame arresters and high velocity explosions will therefore often pass through them for this reason. Flame arresters according to the present invention are therefore preferably designed so that rods in parallel rows are offset with respect to the adjacent row. This makes it necessary for a gas or explosion front to weave in order to pass through the labyrinth. This weaving action and the fact that the gas must follow a path at an angle to the normal axis means that the length of the flame path is increased, making this a more effective flame arrester. Suitable offset angles can vary. Examples are between 30 and 60 degrees, but this is not exhaustive. The continuous weaving action also causes the gas to accelerate and decelerate which causes a small amount of turbulence.

An additional principal advantage of a rod type flame arrester is that it lends itself to being cleaned mechanically, simply by introducing a linear scraping device. This preferably passes over each rod to keep it clean. The scraping device can either be operated by manual effort or automatically.

### BRIEF DESCRIPTION OF DRAWINGS

Embodiments of the present invention will now be described, by way of example, with reference to the accompanying figures, in which:

FIG. 1 is a horizontal cross-section through a first embodiment of the present invention, taken on I-I of FIG. 2;

FIG. 2 is a horizontal view of the example;

FIG. 3 is a horizontal view in the direction of arrow III of FIG. 2;

FIG. 4 is a horizontal cross-section through a second embodiment of the present invention, taken on IV-IV of FIG. 5;

FIG. 5 is a horizontal view of the second embodiment;

FIG. 6 is a view in the direction of an arrow VI of FIG. 5;

FIG. 7 is a horizontal section on a third embodiment;

FIG. 8 is a view on VIII of FIG. 7; and

FIG. 9 is a side view of the third embodiment.

### DETAILED DESCRIPTION OF THE EMBODIMENTS

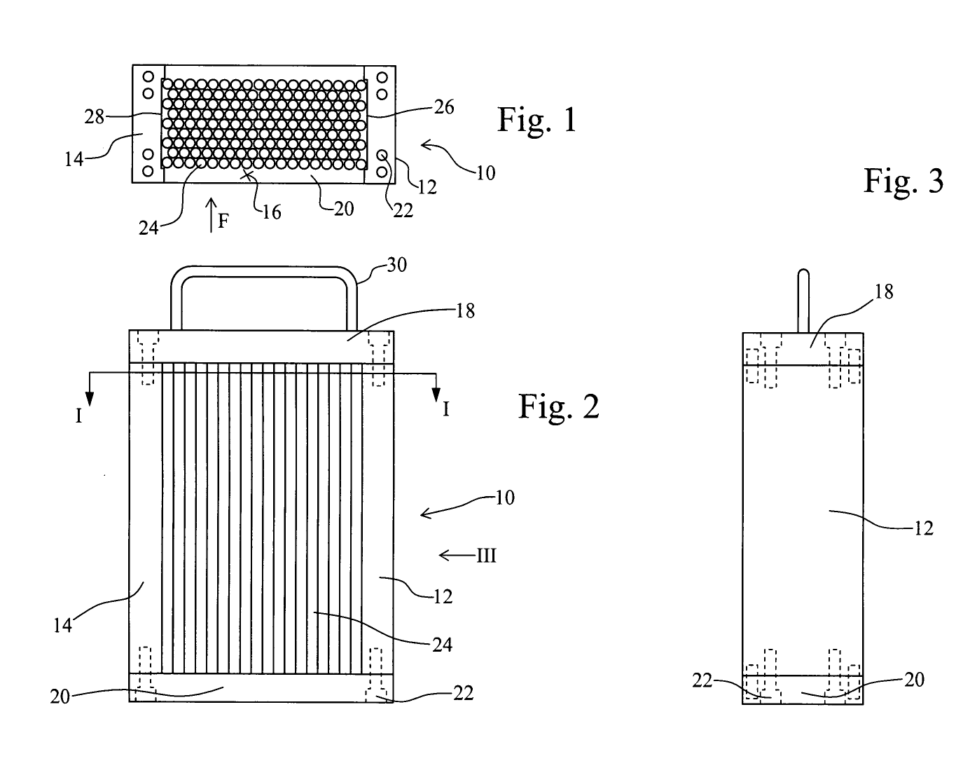

FIGS. 1, 2 and 3 illustrate a first embodiment of the present invention. A flame arrester 10 comprises a pair of side walls 12, 14 which are generally parallel and define between them a flow passage 16 through which air flows in direction F. The top and bottom edges of the flow passage 16 are defined by upper and lower walls 18 and 20. These are secured to the side walls 12, 14 by bolts such as that marked at 22.

An array of parallel circular section rods 24 are provided within the flow passage 16. They are assembled transverse to the flow direction F in a hexagonal pattern such that rods in one row are offset with respect to rods in an adjacent row. Thus, the only route through the flow passage 16 is in the interstices between rods 24, a path which must deviate from a straight line parallel to the passage walls at some point. The rods 24 are generally close packed, insufficiently so as to close off air flow through the passage 16, but sufficiently close as to require significant deviation. As illustrated, the free gap between the rods is less than the diameter of the rods, preferably less than one half of a diameter.

The side walls 12, 14 are recessed at 26, 28 in the vicinity of the array of rods 24. This means that the rods closest the side walls 12, 18 are slightly recessed into the side wall, as viewed in FIG. 2. This prevents a straight line flow path from existing alongside the walls 12, 14.

Finally, a carrying handle 30 is attached to the upper wall 18 to facilitate handling of the arrester. It could equally be attached to one of the side walls 12, 14.

It will be appreciated that this embodiment of the invention provides a simple and straightforward construction of flame arrester which will nevertheless provide good flame arresting performance in combination with a robust nature able to withstand shock in use. In addition, the rods 24 could easily be replaced with pipes, which can then be provided with a suitable coolant as set out above.

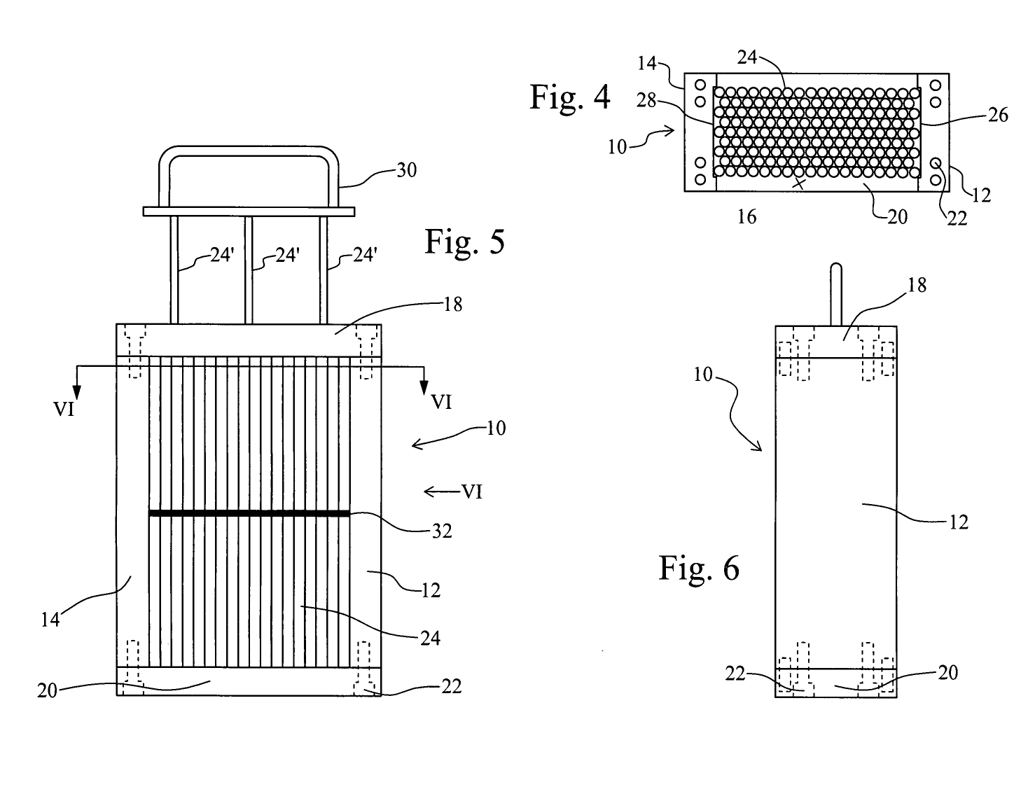

FIGS. 4, 5 and 6 illustrate a second embodiment. In general, this embodiment is identical to that described above with reference to FIGS. 1, 2 and 3. Identical reference numerals are therefore employed to denote corresponding parts.

In this second embodiment, a scraper plate 32 is provided within the array of rods 24. This scraper plate 32 includes an array of circular section apertures corresponding to the circular section rods 24. It can therefore exist within the array of rods 24. A plurality of rods 24′ are fixed at their bottom end to the scraper plate 32 and at their top end to the handle 30, passing through apertures in the upper wall 18. Thus, when the handle 30 is pulled upwardly, the scraper plate 32 is drawn through the array of rods 24, scraping deposits from the surfaces thereof as it passes. After the handle 30 has been pulled to it fullest extent and the scraper plate 32 is adjacent the undersurface of the top wall 18, the handle 30 can be depressed, moving the scraper plate back toward the bottom wall 20. If air is passing through the arrester 10 during this process, the deposits scraped off the rods 24 by the scraper place 32 will become entrained in the air flow and removed from the body of the arrester 10.

Thus, the second embodiment of the invention retains the advantages of the first and also permits the arrester to be cleaned as a routine matter. Conventional arresters require soaking in chemical solutions in order to remove such deposits. In general, this is not practical on a routine or frequent level. Thus, flame arresters according to this embodiment could be fitted to dirty exhausts such as those from a diesel engine, allowing such engines to be used in sensitive environments.

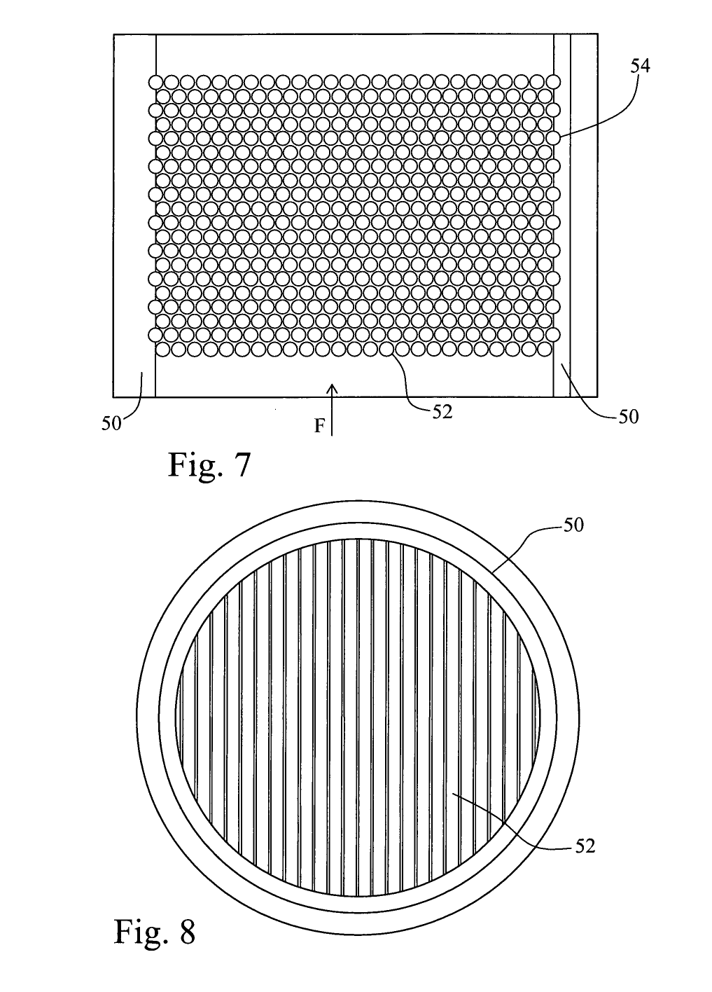

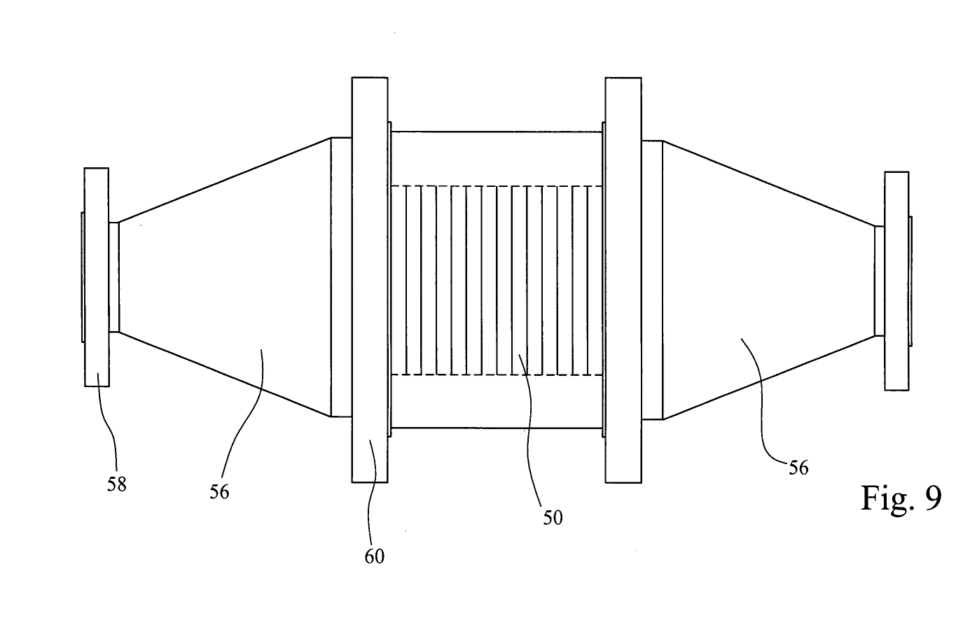

A third embodiment of the invention is shown in FIGS. 7 and 8. In this embodiment, the pair of side walls and upper and lower walls is replaced with a tube 50. This assembly would be suited to pipe line applications, the hoop giving added strength where high pressure detonations may occur. The flow path is therefore within the tube 50, an array of parallel circular rods 52 of varying length being provided within the flow path, although square or polygonal rods can be used. The rods 52 are assembled transverse to the flow direction F in a pattern where alternate rows of rods 52 are aligned and rows between these are offset by one half of the rod pitch. Thus, the only route through the flow passage is in the interstices between the rods 52, a path which must deviate from a straight line parallel to the surrounding hoop 50 at some point.

The rods 52 are generally close packed, insufficiently so as to close off air flow but sufficiently close as to require significant deviation. Where the vertical rods 52 on the outer sides of the array become close to this tube the tube is recessed leg at 54) to ensure that at the point of the tube 90° from the rod axis the maximum gap between the outer rods and the tube wall is consistent with or no greater than the other gap dimensions within the array.

In pipeline applications the diameter of the flow tube 50 containing the array of rods 52 is likely to be significantly greater than the diameter of the pipe into which the element would be fitted. It is therefore necessary to provide each element with a concentric reducer 56 at both the inlet and outlet of the element, illustrated in FIG. 9. Each reducer 56 will be flanged (e.g. at 58, 60) at both ends. At the narrow end the flanges 58 will represent the nominal bore of the tube into which the arrester may be fitted and may be to BS10 or other standard flanges. At the wider end of the reducer again a standard flange 60 will represent the nominal bore of flow tube 50 which contains the array of rods 52. Thus each reducer assembly can be of a standard reducer 56 plus two standard flanges 58, 60. Construction is ideally fully welded, and the flow tube 50 is contained between the wider end of the two reducer assemblies by high tensile studding and nuts.

The arrester can be made of a variety of materials. Stainless steel and other ferrous alloys can assist in heat dissipation, but whilst this may be beneficial in some applications is not essential to the operation of the invention. Accordingly, other materials can be employed such as non-ferrous metals and alloys, ceramics, certain plastics and composites of ferrous alloys and/or these materials.

It will be appreciated that many variations could be made to the above-described embodiments, without departing from the present invention. For example, dimensions, spacings, etc discussed in relation to the third embodiment can be applied to the first and second embodiments, and vice versa.

1. A flame arrester comprising a flow passage in which is disposed an array of adjacent circular section rods arranged in rows, each row being generally co-aligned and arranged transverse to the flow direction, such that fluids flowing in the passage must pass between the rods and the rods forming the rows are offset relative to rods in adjacent rows thereby to require a circuitous flow path for the fluids.

2. A flame arrester according to claim 1 wherein the rods are of solid material.

3. A flame arrester according to claim 1 wherein the rods are tubes.

4. A flame arrester according to claim 3 in which the tubes are adapted to carry cooling fluid.

5. A flame arrester according to claim 4 wherein the tubes carrying the cooling fluid are arranged upstream.

6. A flame arrester according to claim 5 in which the upstream tubes are finned.

7. A flame arrester according to claim 1 in which the offset is at an angle of between 30 and 60 degrees.

8. A flame arrester according to claim 1 further comprising a scraping device disposed between the rods to remove deposits thereon.

9. A flame arrester according to claim 8 in which the scraping device is linked to a manually operated actuator.

10. A flame arrester according to claim 8 in which the scraping device is linked to a powered actuator thereby to allow automatic operation thereof.

11. A flame arrester according to claim 10 in which a timer device is provided, arranged to trigger the powered actuator after an interval.

12. A flame arrester according to claim 1 wherein the flow passage is cylindrical, the axis of the cylinder being aligned with the flow direction.

13. An assembly of a flame arrester according to any preceding claim with a reducer fitted on at least one side thereof to reduce the size of the flow passage.

14. An assembly according to claim 13 in which a reducer is fitted on both sides of the arrester.

15. An assembly according to claim 13 wherein the reducer is attached to the arrester by way of flanges on each part which are bolted together.
